(19) United States
(12) Patent Application Publication
(10) Pub. No.: US 2024/0127543 A1
(43) Pub. Date: Apr. 18, 2024

(54) CONTEXT CONVERSION SYSTEMS AND METHODS FOR GEOMETRIC MODELING

(71) Applicant: Truist Bank, Charlotte, NC (US)

(72) Inventor: Robert Laurence Dessert, Marietta, GA (US)

(73) Assignee: Truist Bank, Charlotte, NC (US)

(21) Appl. No.: 18/046,758

(22) Filed: Oct. 14, 2022

(51) Int. Cl. G06T 19/00; G06Q 20/18; G06T 17/00

(52) U.S. Cl. CPC G06T 19/003; G06Q 20/18; G06T 17/00; G06T 2200/24

(57) ABSTRACT

A context conversion system for geometric modeling is network connected to multiple modeling servers, each providing a respective geometric model. Portions of the geometric models are displayed as three dimensional virtual environments, which are navigable according to user navigation signals prompting movement of a user-representative object frame. Transitions among locations in multiple three dimensional virtual environments are displayed, the transitions selected by virtual use of a context conversion terminal by the object frame under user control. The object frame is displayed as overlaid with graphical accessories, which may be replaced, optionally automatically, when transitioning from t one three dimensional virtual environment to another. The object frame overlaid with graphical accessories make up a user-controlled and user-representative dynamic graphical indicium that navigates the content of multiple modeling servers with at least partial continuity by use of the conversion terminal.

### FIELD

This invention relates generally to the field of graphical modelling, and more particularly embodiments of the invention relate to displaying a user-controlled object frame in multiple virtual environments.

### BACKGROUND

The creation of the internet is generally credited to universities and their activities in interconnecting once disparate computer networks to facilitate collaborations in research. What began as a means for researchers and students to share data, code, and processing time, evolved into a widespread connection platform for people of all walks. While early email exchanges and shared communication threads were likely focused on academic pursuits, human nature broadly repurposed those and other evolving communication means to serve every human interest and even whim. The internet now connects, informs, and entertains people the world over; and of course the wide space and access the internet represents is utilized and driven by advertising.

As computing power evolves, with reference to the processing powers of handheld devices, home-based computers, portable machines such as laptops, and to cloud-computing as well, users are seeking out immersive and at least visually realistic experiences. User develop alter-egos, heroic versions of themselves, and context—specific characters they control in gaming and other virtual environments. These user-representative characters are often termed avatars and users are increasingly spending considerable time, effort, thought and even resources on their avatars.

Akin to the broad purposing of the internet as it developed, uses for the potentially broad space of what is being called the metaverse, which is essentially conducted across the internet, are likely to expand across all human interests. The concept and future of the metaverse go far beyond just a nominal re-terming of the same space now called the internet. A virtual and multi-purpose space is being constructed that is undeniably navigable by humans via computing devices. Humans take pride in their appearances and personal effects as they navigate the physical world. Continuity in their appearances and holdings ground their identities to themselves and to other people. That continuity permits us to recognize our friends and acquaintances. Users of the metaverse are likely take to pride in their avatars and the assets associated with their avatars as well. User names are not sufficiently robust and differentiated to foster recognition with certainty among users at a glance. Currently, avatars are domain or game specific. Thus as the early cosmonauts of the metaverse explore and build their online worlds, avatar continuity is lost as they travel virtually among available environments.

Locomotion among locations in an typical virtual world involves virtual real-time foot travel by a user's avatar, which in some instances can be monotonous and disinteresting. As virtual events such as concerts, festivals, and sport games are popularized, users may be deterred by virtual lines in which avatars slowly progress toward gathering points or spectator stands despite the real world accuracy of such experiences and the virtual venues where they occur. Where rapid travel means are provided within a typical virtual world, for example as teleporters, such means tend to be fixed point-to-fixed point as predefined by site developers and thus are not flexible and fail to cater to user immediate preferences with regard to travel destination upon use of such a teleporter.

### BRIEF SUMMARY

Embodiments of the present invention address the above needs and/or achieve other advantages by providing apparatuses, systems, and methods that enable navigable context conversion in geometric modeling.

In at least one embodiment, a system for navigable context conversion in geometric modeling includes: a computing system including one or more processor and at least one of a memory device and a non-transitory storage device, wherein said one or more processor executes computer-readable instructions; and a network connection for operatively connecting the computing system to multiple modeling servers, each of the modeling servers providing a respective geometric model, the multiple modeling servers comprising at least a first modeling server providing a first geometric model and a second modeling server providing a second geometric model. Upon execution of the computer-readable instructions, the computing system performs steps including: accessing at least a portion of the first geometric model; causing display of the portion of the first geometric model; receiving a user navigation signal prompting movement of a user-controlled and user-representative object frame in the first geometric model; determining whether the user-representative object frame is in an activation proximity of a context conversion terminal at a first location in the first geometric model; accessing at least a portion of the second geometric model; and causing display of a portion of the second geometric model.

In some examples, causing display of the portion of the first geometric model comprises causing display of a representation of the context conversion terminal as a virtual kiosk.

The context conversion terminal may be or associated with a non-fungible token (NFT).

Causing display of the portion of the first geometric model may include causing display of a user customized first graphical indicium, which is based at least in part on the object frame and includes user-selected first graphical accessories overlaying the object frame.

Causing display of the portion of the second geometric model may include causing display of a second graphical indicium, which based at least in part on the object frame and includes user-selected second graphical accessories overlaying the object frame.

In some examples, the first geometric model includes a first three dimensional virtual environment; the second geometric model includes a second three dimensional virtual environment; and the computing system further causes displaying transition of the object frame overlaid by the first graphical accessories in the first three dimensional virtual environment to the object frame overlaid by the second graphical accessories in the second three dimensional virtual environment.

The object frame may be or associated with a non-fungible token (NFT).

In some examples, the computing system further causes displaying transition, by use of the context conversion terminal, of the object frame overlaid by the second graphical accessories in the second three dimensional virtual environment to the object frame overlaid by the second graphical accessories in the second three dimensional virtual environment.

The computing system, in some embodiments, automatically replaces the first graphical accessories with the second graphical accessories when transitioning from the first three dimensional virtual environment to the second three dimensional virtual environment.

The computing system may cause displays of transitions among multiple three dimensional virtual environments, each according to a respective geometric model provided by a respective one of the multiple modeling servers, the transitions selected by virtual use of the context conversion terminal by the object frame under user control.

The computing system may cause displays of transitions among user-selected locations in the multiple three dimensional virtual environments, the user-selected locations selected by virtual use of the context conversion terminal by the object frame under user control.

In at least one embodiment, a system for navigable context conversion in geometric modeling includes a computing system including one or more processor and at least one of a memory device and a non-transitory storage device. The one or more processor executes computer-readable instructions. A network connection operatively connects the computing system to multiple modeling servers, each of the modeling servers providing a respective geometric model. The computing system performs steps including: accessing at least a respective portion of each geometric model; and causing successive presentations of the portions of the geometric models, each said portion of each geometric model represented as a respective corresponding three dimensional virtual environment navigable by user control. The presentations are successively caused by virtual use of a context conversion terminal displayed in at least one of said virtual environment by an object frame under user control.

In each respective three dimensional virtual environment, at least a portion of the object frame may be displayed as overlaid with respective graphical accessories.

Causing successive presentations may include automatically transitioning the graphical accessories overlaying the object frame as the presentations transition among the three dimensional virtual environments.

In at least one embodiment, a method provides for navigable display conversion, via a computing system at least partially under user control. The computing system includes one or more processor, at least one of a memory device and a non-transitory storage device, and a network connection for operatively connecting the computing system to multiple modeling servers. Each of the modeling servers provides a respective geometric model. The multiple modeling servers include at least a first modeling server providing a first geometric model and a second modeling server providing a second geometric model. The method includes, upon execution of the computer-readable instructions by the at least one processor: accessing at least a portion of the first geometric model; causing display of the portion of the first geometric model; receiving a user navigation signal prompting movement of a user-controlled and user-representative object frame in the first geometric model; determining whether the object frame is in an activation proximity of a context conversion terminal at a first location in the first geometric model; accessing at least a portion of the second geometric model; and causing display of a portion of the second geometric model.

Causing display of the portion of the first geometric model may include causing display of a user customized first graphical indicium. The first graphical indicium is based at least in part on the object frame and comprises user-selected first graphical accessories overlaying the object frame.

Causing display of the portion of the second geometric model may include causing display of a second graphical indicium. The second graphical indicium is based at least in part on the object frame and comprises user-selected second graphical accessories overlaying the object frame.

The computing system causes displays of transitions among user-selected locations in multiple three dimensional virtual environments, each according to a respective geometric model provided by a respective one of the multiple modeling servers, the transitions selected by virtual use of the context conversion terminal by the object frame under user control.

The above summary is to be understood as cumulative and inclusive. The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system and environment thereof for navigating context conversion in geometric modeling, in accordance with at least one embodiment of the present invention;

FIG. 2A illustrates equipment items, according to at least one embodiment, used in a virtual reality (VR) session.

FIG. 2B shows a user view of a simulated environment in a VR session via a helmet or visor.

FIG. 3A illustrates an AR session in which a user views a background scene through an AR equipped mobile device.

FIG. 3B shows the AR image 306 on the mobile device 106.

FIG. 4 shows organizational categories of graphical modeling content and a graphical representation of a context conversion terminal for user navigation among the content, according to at least one embodiment.

FIG. 5 shows a display, for example in a VR presentation, of a portion of a first geometric model and the context conversion terminal of FIG. 1 with a user-customized graphical indicium.

FIG. 6 shows a display, for example in a VR presentation, of a portion of a second geometric model and the context conversion terminal of FIG. 1 with another user-customized graphical indicium.

FIG. 7 shows a display, for example in a VR presentation, of the context conversion terminal enabling user selection of a conversion destination and several examples of user-customized graphical indicia.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

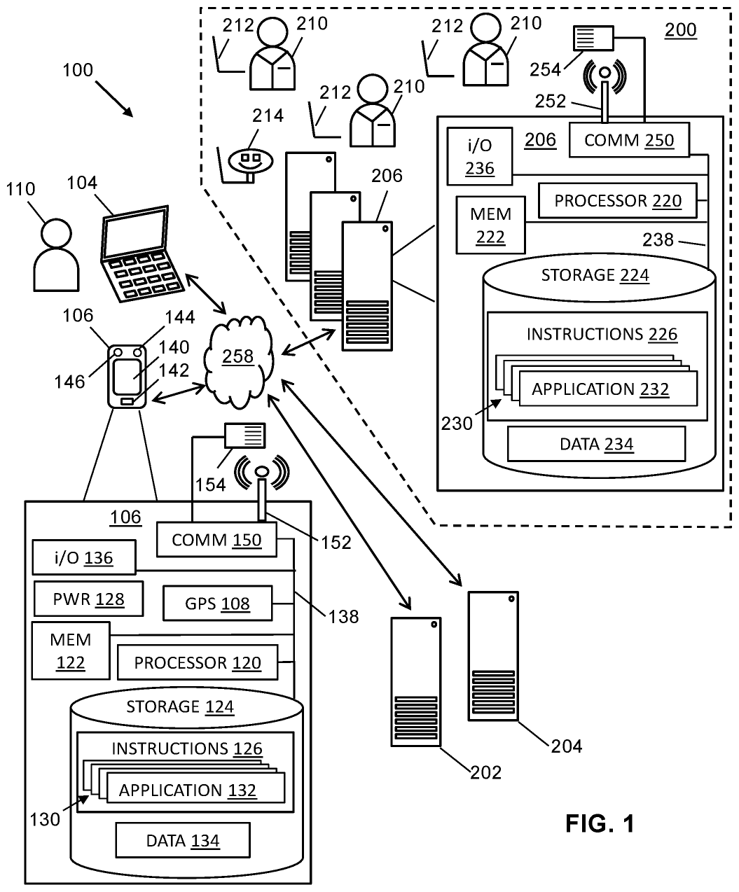

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

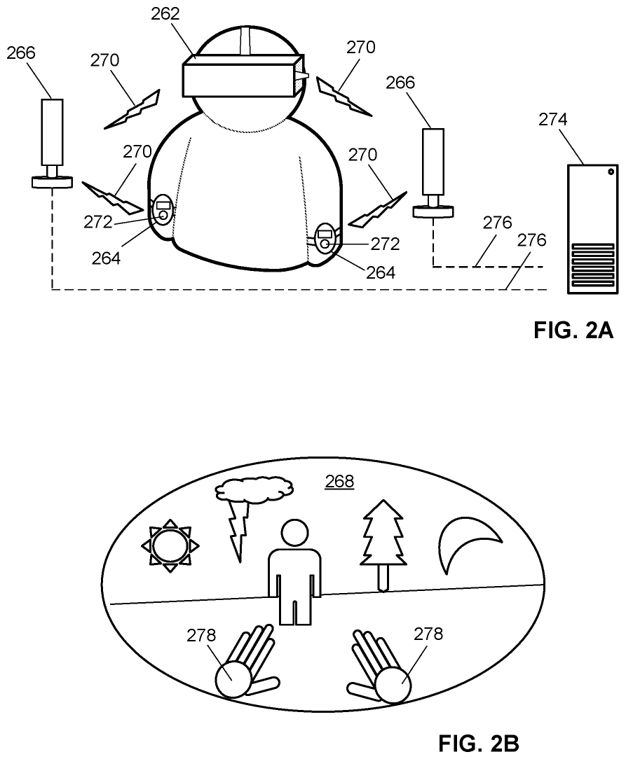

The above-described systems and computing devices, in some embodiments, are used in whole or in part to implement virtual reality (VR) and/or augmented reality (AR) functioning. Virtual reality refers to a computer-generated simulation of a three-dimensional image or environment that can be interacted with in a seemingly real or physical way by a person using special electronic equipment, such as a visor or helmet with an internal screen, and gloves, hand-held controller, and/or other effects fitted with sensors. A VR experience is typically immersive, offering the user a typically entirely artificial computer-generated environment. As vision of the real world around the user is occluded by a visor or helmet, a VR session typically occurs indoors and/or in a safe controlled environment for the safety of the user. VR equipment items are typically interactive devices represented in FIG. 2A as a visor or helmet 262, hand-held or mounted controllers 264, and sensors 266. Connections 270 in FIG. 2A represent interconnectivity among the visor or helmet 262, controllers 264, and sensors 266. The connections 270 may be wireless as represented in FIG. 2A and/or may included wired connections as well.

VR applications immerse the user in a computer-generated environment (FIG. 2B) that simulates reality through the use of the interactive devices. The helmet or visor provides the user with a stereoscopic view 268 of animated images in the simulated environment. The illusion of “being there” (telepresence) is effected by motion sensors that pick up the user's movements to enable adjustment of the view provided the user in real time. Thus, a user can tour a simulated suite of rooms, experiencing changing viewpoints and perspectives that are convincingly related to their own head turnings and steps. The hand-held or mounted controllers 264 typically include buttons and/or triggers 272 by which user actions are relayed to the computing device or system 274 to effect user control of their simulated character and/or to implement user actions with the simulated environment. The hand-held or mounted controllers 264 can be equipped with force-feedback devices that provide the sensation of touch. The hand-held or mounted controllers 264 can be ergonomically formed for comfort and secure grasp in use.

The user can, for example, pick up and manipulate objects that they see in the virtual environment. Visual confirmation of hand-held items and their manipulation can be presented to the user in the simulated environment via a simulated view of the hands, which may appear as character hands 278, such as robot, alien, athlete, soldier or other character hands. Connections 276 in FIG. 2A represented interconnectivity between the sensors and/or other interactive devices with a computing device or system 274 by which calculations and other operation are conducted to dynamically produce the changing simulated environment in which user actions such as hand movements, head movements (looking up, down, left, and right), and user-positioning within a safe environment are typically all represented in the simulated environment. The connections 276 may be wired as represented in FIG. 2A and/or may be or include wireless connections as well. The computing device or system 274 may represent any of the user computing device 104, the mobile device 106, the computing system 206 of the enterprise system 200, and/or the external systems 202 and 204 (FIG. 1). A visual VR session is illustrated in FIG. 2B. Audio information may be provided as well, for example via speakers within or mounted on the visor or helmet 262 or other nearby equipment items. A VR session can be used for gaming, viewing information, navigation, and many other uses.

Augmented reality (AR) refers to the integration of digital information with the user's environment in real time. Unlike virtual reality (VR), which creates a totally artificial environment, AR users experience a real-world environment with computer-generated perceptual information visually combined or overlaid on real world images. The computer-generated simulation of a three-dimensional image or environment can be interacted with in a seemingly real or physical way, typically using a mobile phone such as the user mobile device 106. Because an AR experience does not typically greatly occlude the user's view of their real environment, AR use is potentially more mobile and safer to use outdoors and/or in less controlled environments than VR. However, electronic equipment, such as the visor or helmet 262 (FIG. 2A) and hand-held or mounted controllers 264 may be used as well.

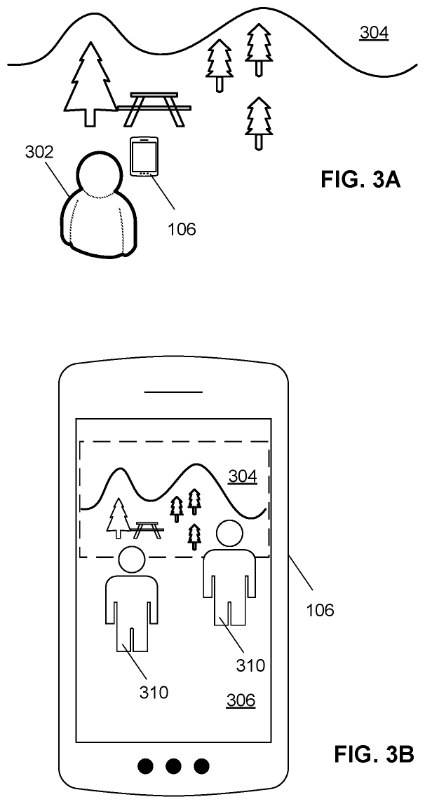

FIG. 3A illustrates an AR session in which a user 302 views a background scene 304 through an AR equipped mobile device 106. FIG. 3B shows the AR image 310 on the mobile device 106. A visual AR session is illustrated. Audio information may be provided as well via speakers of the device 106. The AR image 306 includes characters 310 combined with or overlaid in the background scene 304. Any number of artificial characters and/or objects can be included. An AR session can be used for gaming, viewing information, navigation, and many other uses.

VR and AR experiences are increasingly available online and modern navigation of online content is expected increasingly be navigated by these technologies, giving rise to the term metaverse. The metaverse is essentially conceived as networked simulated digital environments permitting high user engagement with not only online services and content, but social connections as well. Persistent simulated virtual worlds have arrived, using blockchain technology in some instances to promote continuity, credibility, and even security where virtual assets are concerned. The metaverse is evolving as a multi-world space where AR and VR to create spaces for interaction online facilitated by mobile internet as well as augmented and virtual reality headsets.

Several types of sites have appeared. Their features are somewhat shared and somewhat differentiated. Although any given site may be considered as one or more of the below described types, some categorization is useful for understanding the current state and future of the metaverse.

Sites, domains, or platforms known as “walled gardens” tend to have controlled access, and tend to be event-based and hyper-realistic. A typical walled garden has centralized ownership and guideline governance, offers a tailor-made experience, and utilizes fiat currency. Non-limiting examples of walled gardens include Surreal, Zoan, Burst, Spatial, Hyperreal, and Omniya.

Online games are currently highly popular. They tend to have centrally-controlled governance, utilize private token currency, and offer a managed experience. Non-limiting examples of online games include Roblox, Axie Infinity, Fortnite, Minecraft, and Upland.

Sites, domains, or platforms known as “open lands” tend to have open access, and some are always on or persistently active. Decentralized governance and limited guidelines are attracting relative high investment relative to other platform types. Interoperability is also a relative characteristic of open lands, where non-fungible tokens (NFT) and cryptocurrencies such as stablecoins are used to manage and exchange ownership of assets. Non-limiting examples of open lands include Somnium Space, NFT Worlds, Substrata, Cryptovoxels, Decentraland, and Netvrk.

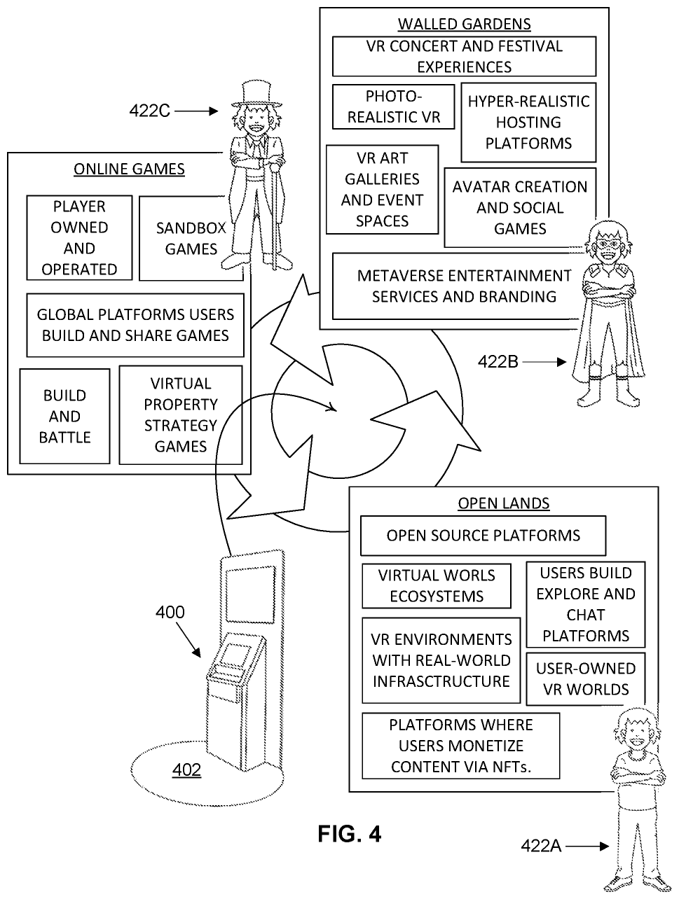

Walled gardens, online games, and open lands are represented as separate in FIG. 4, which also further provides examples of their uses and features. Navigation among them is also referenced in FIG. 4. Any given site, domain, or platform can have characteristics of one or more of these and other types of sites, domains, or platforms, such that delineations between walled gardens, online games, and open lands, are not necessarily absolute or universally agreed upon. Hosting services at sites, domains, or platforms providing navigable virtual experiences are referenced and represented herein as modeling servers each providing a respective geometric model.

A typical user in the metaverse is represented by and controls a personalized and movable graphical indicium defining an avatar. These personalized user-representative and user-controlled graphical indicia can take different forms or shapes. Users can become quite attached to, and invested in, their customized graphical indicia, considering them caricatures of themselves, or second even improved identities. A typical user deploys their customized graphical indicium as their representative presence in any given virtual world.

FIG. 4 represents an example in which a user prefers a particular graphical indicium 422A when visiting open lands type sites, domains, or platforms, and prefers another graphical indicium 422B when visiting walled gardens, and prefers yet another graphical indicium 422C when playing online games.

Like a user's physical form, a customized graphical indicium may have many outward appearances by use of accessories amounting to virtual clothing, costumes, and gear. Continuity of a customized graphical indicium, for example by which users recognize each other in their shared virtual experiences, is provided by a base form, in correspondence for example to a human body. For descriptive purpose, the underlying base form of a customized graphical indicium is referenced herein as an object frame. Like a physical body, an object frame can be endowed with humanoid on animal-like attributes, like lower and upper torsos, operable limbs, and faces capable of exhibiting non-verbal cues. In a typical deployment, a customized graphical indicium may include user-selected graphical accessories overlaying the object frame. In some cases, the graphical accessories are virtually operable as well, as in the case of tools, weapons, armor, and other items.

Ownership and attributes of a customized graphical indicia, the object frame thereof, and the accessories thereof, may be recorded and safe-guarded via NFT security. User assets such as funds (virtual money), for example carried and/or represented by a virtual wallet, may be similarly protected. A non-fungible token (NFT) is generally a record on a blockchain associated with a particular asset, which can be digital, virtual, or physical. Ownership of an NFT is recorded in the blockchain, and can be transferred, allowing NFTs to be sold and traded.

In some instances, assets may be in the form of, or may be transacted via, stablecoins, which are cryptocurrencies where the price is indexed to a reference asset. The reference asset may be fiat money, exchange-traded commodities, or a cryptocurrency.

In implementing inventive systems and methods according to these descriptions, virtual teleporter NFT objects are created for open lands and/or wherever metaverse interoperabilty and user-experience continuity for assets and digital identity are to be established and maintained as users travel virtually. Microspaces and/or ad spaces can be leased at strategic virtual locations in each such open land or other platform or space. The teleporter enables virtual travel from a departure virtual environment context to a user-selected destination virtual environment context with digital identity transfer of a user-representative object frame in as seamless a fashion possible. Such a teleporter in some instances here is termed a context conversion terminal 400.

While a user may have preferences for their avatar, often, it is the restrictions, constraints and themes of the metaverse land (ex—Decentraland, The Sandbox, Fortnite) that dictate the detail, fidelity, feature shape, and wardrobe available for a user's avatar. A user may “wish” their avatar looked the same across multiple lands, but the land doesn't allow it. A teleporter as described herein, in some embodiments, accounts and/or compensates for the limitations, restrictions and themes of the destination lands especially in the case where the user has never been there before and a new “reasonable proximity” avatar will need to be generated. Another for instance: a user teleporting from Fortnite which is typically themed in medieval battle style, to a corporate business land would not be expected to retain its battle shield and armor clothing, but instead be dressed in business casual or perhaps a suit.

To utilize a context conversion terminal 400, virtual wallet reading may be enabled upon customized graphical indicium arrival in a virtual proximity zone 402, for example as represented by the circular area in FIG. 4. Features and actions enabled at the context conversion terminal 400 within the virtual proximity zone 402 can include enabling micro-exchange of funds, such USD funds, to the virtual token, or meta token, of the current or destination virtual environment context. As with real-world access through kiosks such as ATMs, a context conversion terminal 400 can provide a private view of user account balances, such as a user's meta token balance. The context conversion terminal 400 in some embodiments enables access to assistance, for example via a virtual agent 214 and/or a human agent 210 of the enterprise system 200, for advisory communications, in textual, auditory, spoken, and/or graphical format.

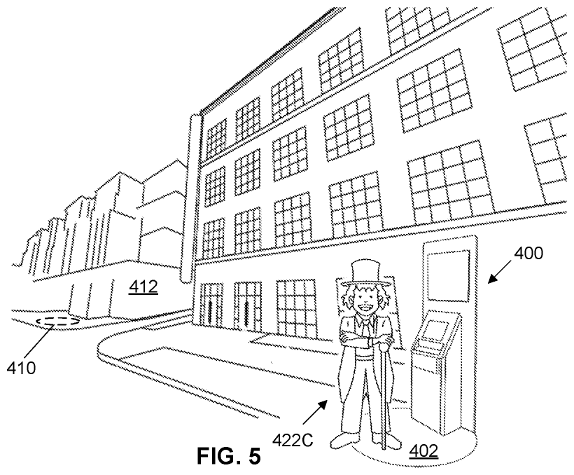

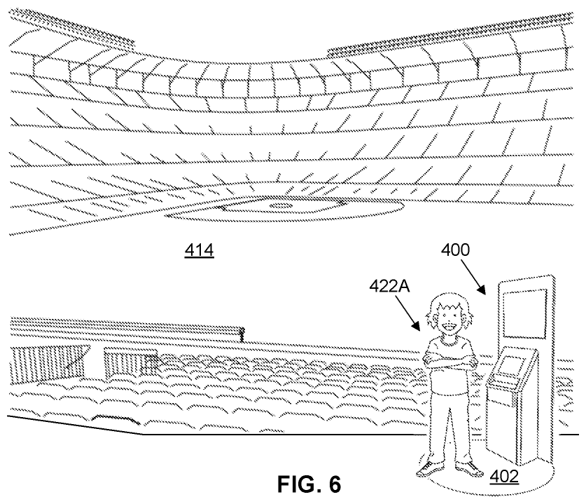

In various embodiments, the system 200 provides navigable context conversion in geometric modeling, for example from one virtual online environment to another. The computing system 206, the at least one of a memory device 222 and a non-transitory storage device 224, and the one or more processor (220,120) implement various examples by which a user interacts with and at least partially controls a user-representative and user-controlled object frame, over which graphical accessories may be overlaid for a complete avatar appearance. The network connection operatively connects the computing system 200 to multiple modeling servers, for example as represented by the external systems 202 and 204 in FIG. 1. Each of the modeling servers provides a respective geometric model. In the expressly illustrated example, the multiple modeling servers include at least a first modeling server, represented by external system 202, and a second modeling server, represented by external system 204, the respective geometric models of which are represented in FIGS. 5 and 6.

In the particular illustrated and non-limiting examples, the geometric model of the first modeling server, referenced nominally as a first geometric model 412 (FIG. 5), is represented as a three-dimensional urban virtual environment. The geometric model of the second modeling server, referenced nominally as a second geometric model 414 (FIG. 6), is represented as a three-dimensional sports arena virtual environment. These description relate as well to other virtual environment types.

Upon execution of the computer-readable instructions, the computing system performs steps including accessing at least a portion of the first geometric model, causing display of the portion of the first geometric model as represented in FIG. 5, and receiving a user navigation signal prompting movement of a user-controlled object frame in the first geometric model. The movement of the object frame corresponds to, for example, user-representative customized graphical indicium movement as the user navigates the first geometric model, for example by use of the controllers 264 (FIG. 2A) or other user-operable navigation buttons or controls, being physical or virtual, and being local on a user device or accessible to the user via a connected session to the computing system 200 or the external system 202.

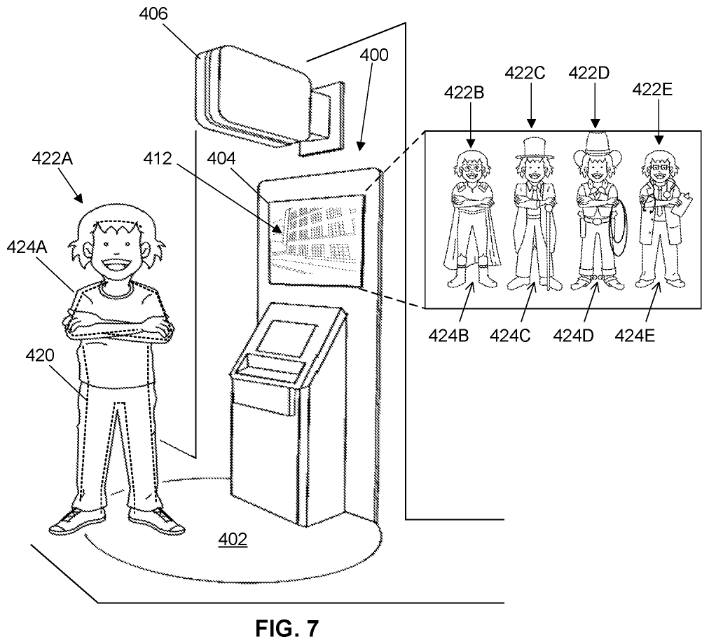

A non-limiting example of an object frame 420 is shown in FIG. 7 in dashed line, representing that various graphical accessories, appearing as clothing items in the drawings, overlay the object frame 420 to constitute several examples of user-customized graphical indicia. That is, a user-customized graphical indicium 422A having a casual appearance is shown in FIG. 7 as the user-representative object frame 420 overlaid with graphical accessories 424A. In other non-limiting costumed examples: a user-customized graphical indicium 422B having a caped and masked appearance is shown in FIG. 7 as the user-representative object frame overlaid with graphical accessories 424B; a user-customized graphical indicium 422C having a festive appearance is shown as the user-representative object frame overlaid with graphical accessories 424C including a hat and cane; a user-customized graphical indicium 422D having a rodeo appearance is shown as the user-representative object frame overlaid with graphical accessories 424D including boots with spurs and a rope; and a user-customized graphical indicium 422E appearing as a physician is shown as the user-representative object frame overlaid with graphical accessories 424E including a stethoscope.

A virtual display 404 of the context conversion terminal 400 can show, as exemplified in the first display example view of FIG. 7, a destination virtual environment for selection as a destination by the user. The first geometric model 412 of FIG. 5, represented as a three-dimensional urban virtual environment, is shown as displayed in FIG. 7.

FIG. 7 further illustrates, in an enlarged alternative display view, that the context conversion terminal 400 can display various graphical accessories (424B, 424C, 424D, and 424E are non-limiting examples) and various user-customized graphical indicia (422B, 422C, 422D, and 422E are non-limiting examples) for user selection by virtual use of the context conversion terminal 400 via the user-representative object frame 420.

The computing system 200, in various embodiments, performs steps including determining whether the user-representative object frame is in an activation proximity of a context conversion terminal at a first location in the first geometric model. For example as represented in FIGS. 4-7, an activation proximity of a context conversion terminal 400 is represented as the virtual proximity zone 402.

In the example of FIG. 5, features of the terminal become enabled automatically, or by further user action, when the customized graphical indicium 422C arrives in the virtual proximity zone represented by the circular area of the virtual proximity zone 402. The terminal can then be used to vary the context of the user experience, such as by virtual teleportation to another virtual location, which can be in the same virtual environment of the first geometric model, or, as represented in transitioning from FIG. 5 to FIG. 6 in the illustrated example, can be in another virtual environment such as that of the second geometric model. To represent such teleportation in the user perspective, at least a portion of the second geometric model is accessed; and at least that portion of the second geometric model is displayed as represented in FIG. 6.

As shown in FIGS. 4-7, the context conversion terminal 400 can be displayed as a virtual kiosk. A representative graphical form, such as the illustrated kiosk or other form, is advantageous by serving to identify the terminal(s) in one or more virtual environment, permitting users to recognize access locations and navigate their customized graphical indicia to such access locations for further travel and/or use of other functions available by way of the terminal(s). To maintain control and ownership of the terminal(s), the context conversion terminal may be a non-fungible token (NFT). In FIG. 7, the terminal is shown with further virtual signage 406 further facilitating familiarity for locating and accessing the terminal by a user.

Display, displaying, and causing to display in these descriptions with reference to FIGS. 4-7 describes at least VR presentations to a user as in FIGS. 2A-2B, AR presentations to a user as in FIGS. 3A-3B, and other displayed presentation types.

The displayed portion of the first geometric model is displayed in FIG. 5 with a user-customized first graphical indicium 422C, which is based at least in part on the object frame 420 (FIG. 7) and includes user-selected first graphical accessories 424C overlaying the object frame. The displayed portion of the second geometric model is displayed in FIG. 6 with a second graphical indicium 422A, which based at least in part on the object frame 420 and includes user-selected second graphical accessories 424A overlaying the object frame. As display is transitioned from the first three dimensional virtual environment (FIG. 5) to the second three dimensional virtual environment (FIG. 6), and the computing system further causes displaying transition of the object frame overlaid by the first graphical accessories 424C to the object frame overlaid by the second graphical accessories 424A. The object frame may be a non-fungible token (NFT).

The user is represented in various virtual environments by user-selected graphical indicia made up of the object frame 420 overlaid by the graphical accessories, which can be varied or maintained as virtual travel among the virtual environments. That is, the first graphical accessories and second graphical accessories overlaying the object frame may be different or may be the same. The context conversion terminal 400, in some embodiments, permits user selection of the graphical accessories (424A, 424B, 424C, 424D, 424E) as virtual travel to different locations having different contexts is conducted so as to present a context appropriate appearance in the user-representative graphical indicia (422A, 422B, 422C, 422D, 422E), akin to a traveler changing clothes at various locations in an itinerary of destinations.

The first graphical accessories and second graphical accessories may represent any number of differentiated accessory sets, which may have some common elements or may be mutually exclusive and distinct. The accessories may be pre-selected by the user for each virtual environment, and once pre-selected, the pre-selected accessories may be automatically displayed as overlaying the object frame upon transition to the respective virtual environment. That is, in some examples, the computing system 200 automatically replaces the first graphical accessories with the second graphical accessories when transitioning from the first three dimensional virtual environment to the second three dimensional virtual environment.

Although the above descriptions particularly describe two modeling servers as represented by the external systems 202 and 204 in FIG. 1, these descriptions relate as well to any number of modeling servers by extension. The network 258 operatively connects the computing system 200 to multiple modeling servers, which can be of any number, each of the modeling servers providing a respective geometric model. The computing system performs steps including: accessing at least a respective portion of each geometric model; and causing successive presentations of the portions of the geometric models, each said portion of each geometric model represented as a respective corresponding three dimensional virtual environment navigable by user control. The presentations are successively caused by virtual use of the context conversion terminal 400 displayed in at least one of said virtual environment by an object frame under user control.

In some instances, the context conversion terminal 400 may not be displayed at all virtual departure and arrival points in virtual environments. For example, in some geometric models, according to preferences of third parties managing the modeling servers represented by the external systems 202 and 204, virtual locations are leased or prohibited for placement of additional permanent or fixed virtual structures. In such embodiments, the user may set a virtual fixed location in a virtual environment to which to travel, for example from a context conversion terminal position, and from which to return, for example to a context conversion terminal position, or otherwise further travel, without a context conversion terminal being displayed at the virtual fixed location.

In some embodiments, the first modeling server and the second modeling server are owned, provided, managed, or correspond to metaverse content providers, each providing a respective geometric model by which a respective virtual world or environment is displayed at least in part to a user in a VR presentation. The first modeling server and the second modeling server can each be characterized as providing content representing walled gardens, online games, and open lands. In at least one embodiment, at least one of the first modeling server and the second modeling server are owned, provided, managed, or correspond to at least one of Surreal, Zoan, Burst, Spatial, Hyperreal, Omniya, Roblox, Axie Infinity, Fortnite, Minecraft, Upland, Somnium Space, NFT Worlds, Substrata, Cryptovoxels, Decentraland, and Netvrk, as non-limiting and non-exclusive examples. In such embodiments, the first modeling server and the second modeling server can be owned, provided, managed, or correspond to separate, optionally unaffiliated, content providers. Thus, features and advantages of inventive context conversion as described herein provide for user navigation among multiple metaverse environments with convenience and almost seamless continuity from a user perspective, in which the user experiences virtual travel or context transfer from the content of a first modeling server presented as one virtual environment to the content of the second modeling server presented as another virtual environment in a VR presentation thereby connecting previously disparate portions of the metaverse.

A context conversion terminal according to these descriptions can be, in some embodiments, a high profile object in a virtual environment. A context conversion terminal according to these descriptions can be, in some embodiments, a low profile object in a virtual environment. That is, a context conversion terminal and/or a user-set or otherwise established virtual fixed location or travel point where arrival and departure can occur can be a marked or unmarked location with respect to visibility by the user and/or other users. A virtual fixed location or travel point can be marked by a simple graphical indicator 410 such as circle (see dashed line representation in FIG. 5), a dot, an arrow, or a color-highlighted or relatively brightened or darkened indication.

The metaverse, for example as explored via VR sessions can be an immersive virtual experiences, of which geometric modeling is an underlying basis or part, without limiting the context of the metaverse to being only being a geometrically modeled space in 2D, 2.5D and 3D. These descriptions entail a rethinking of the traditional internet hyperlink, and that the metaverse establishes “presence” via a user's digital avatar. Visiting a conventional website, even a chatroom, one is there alone and cannot see anyone else, converse with them, and observe their behaviors. At best one see the result of an interaction of another user on the environment for which one can react to. The metaverse is different. When you go to a space, you actually see the others there, are usually able to converse and at least observe what they are doing. You are there, almost the same as physically habituating a space in the real world. As such, a traditional hyperlink is not entirely satisfactory. The above descriptions satisfy a need to also bring across your digital existence to the resultant location. Thus, context conversion and geometric modeling from a user perspective constitute presence modeling and/or immersive experience modeling where inhabitant presence is identified. Presence incorporates time, just as in the real world, and may require modification of either contextual positioning (someone else is standing there) or digital identity attributes (ex.—modification of wardrobe based on difference in time of “day,” for example the removal of sunglasses as one example).

By facilitating transfer, reuse, and continuity in the user-representative object frame, graphical accessories, and user-customized graphical indicia, considerable user time is conserved by avoiding repetitive reconstruction of such effects. Thus, data traffic on network connections is reduced, improving network efficiencies, reducing latencies, thereby improving the functioning or networked computers, and reducing operating costs.

The above advantages and features can be implemented in various system and device hardware examples, and can also be practiced as one or more methods by which to provide for navigable display conversion via a computing system at least partially under user control in keeping with the above descriptions. Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for navigable context conversion in geometric modeling comprising:
a computing system including one or more processor and at least one of a memory device and a non-transitory storage device, wherein said one or more processor executes computer-readable instructions; and
a network connection for operatively connecting the computing system to multiple modeling servers, each of the modeling servers providing a respective geometric model, the multiple modeling servers comprising at least a first modeling server providing a first geometric model and a second modeling server providing a second geometric model,
wherein, upon execution of the computer-readable instructions, the computing system performs steps comprising:
accessing at least a portion of the first geometric model;
causing display of the portion of the first geometric model;
receiving a user navigation signal prompting movement of a user-controlled object frame in the first geometric model;
determining whether the user-representative object frame is in an activation proximity of a context conversion terminal at a first location in the first geometric model;
accessing at least a portion of the second geometric model; and
causing display of a portion of the second geometric model.

2. The system of claim 1, wherein causing display of the portion of the first geometric model comprises causing display of a representation of the context conversion terminal as a virtual kiosk.

3. The system of claim 2, wherein the context conversion terminal comprises a non-fungible token (NFT).

4. The system of claim 1, wherein causing display of the portion of the first geometric model comprises causing display of a user customized first graphical indicium, wherein the first graphical indicium is based at least in part on the object frame and comprises user-selected first graphical accessories overlaying the object frame.

5. The system of claim 4, wherein causing display of the portion of the second geometric model comprises causing display of a second graphical indicium, wherein the second graphical indicium is based at least in part on the object frame and comprises user-selected second graphical accessories overlaying the object frame.

6. The system of claim 5, wherein:
the first geometric model comprises a first three dimensional virtual environment;
the second geometric model comprises a second three dimensional virtual environment; and
upon execution of the computer-readable instructions, the computing system further causes displaying transition of the object frame overlaid by the first graphical accessories in the first three dimensional virtual environment to the object frame overlaid by the second graphical accessories in the second three dimensional virtual environment.

7. The system of claim 6, wherein the object frame comprises a non-fungible token (NFT).

8. The system of claim 6, wherein upon execution of the computer-readable instructions, the computing system further causes displaying transition, by use of the context conversion terminal, of the object frame overlaid by the second graphical accessories in the second three dimensional virtual environment to the object frame overlaid by the second graphical accessories in the second three dimensional virtual environment.

9. The system of claim 8, wherein the computing system automatically replaces the first graphical accessories with the second graphical accessories when transitioning from the first three dimensional virtual environment to the second three dimensional virtual environment.

10. The system of claim 6, wherein the computing system causes displays of transitions among multiple three dimensional virtual environments, each according to a respective geometric model provided by a respective one of the multiple modeling servers, the transitions selected by virtual use of the context conversion terminal by the object frame under user control.

11. The system of claim 10, wherein the computing system causes displays of transitions among user-selected locations in the multiple three dimensional virtual environments, the user-selected locations selected by virtual use of the context conversion terminal by the object frame under user control.

12. A system for navigable context conversion in geometric modeling, the system comprising:
a computing system including one or more processor and at least one of a memory device and a non-transitory storage device, wherein said one or more processor executes computer-readable instructions; and
a network connection for operatively connecting the computing system to multiple modeling servers, each of the modeling servers providing a respective geometric model,
wherein, upon execution of the computer-readable instructions, the computing system performs steps comprising:
accessing at least a respective portion of each geometric model; and
causing successive presentations of the portions of the geometric models, each said portion of each geometric model represented as a respective corresponding virtual environment navigable by user control,
wherein the presentations are successively caused by virtual use of a context conversion terminal displayed in at least one of said virtual environment by an object frame under user control.

13. The system of claim 12, wherein the context conversion terminal is displayed as a virtual kiosk.

14. The system of claim 13, wherein the context conversion terminal comprises a non-fungible token (NFT).

15. The system of claim 12, wherein, in each respective virtual environment, at least a portion of the object frame is displayed as overlaid with respective graphical accessories.

16. The system of claim 15, causing successive presentations comprises automatically transitioning the graphical accessories overlaying the object frame as the presentations transition among three dimensional virtual environments.

17. A method for navigable display conversion, via a computing system at least partially under user control, the computing system comprising one or more processor, at least one of a memory device and a non-transitory storage device, and a network connection for operatively connecting the computing system to multiple modeling servers, each of the modeling servers providing a respective geometric model, the multiple modeling servers comprising at least a first modeling server providing a first geometric model and a second modeling server providing a second geometric model, the method comprising, upon execution of the computer-readable instructions by the at least one processor:
accessing at least a portion of the first geometric model;
causing display of the portion of the first geometric model;
receiving a user navigation signal prompting movement of a user-controlled object frame in the first geometric model;
determining whether the user-representative object frame is in an activation proximity of a context conversion terminal at a first location in the first geometric model;
accessing at least a portion of the second geometric model; and
causing display of a portion of the second geometric model.

18. The method of claim 17, wherein causing display of the portion of the first geometric model comprises causing display of a user customized first graphical indicium, wherein the first graphical indicium is based at least in part on the object frame and comprises user-selected first graphical accessories overlaying the object frame.

19. The method of claim 18, wherein causing display of the portion of the second geometric model comprises causing display of a second graphical indicium, wherein the second graphical indicium is based at least in part on the object frame and comprises user-selected second graphical accessories overlaying the object frame.

20. The method of claim 19, wherein the computing system causes displays of transitions among user-selected locations in multiple three dimensional virtual environments, each according to a respective geometric model provided by a respective one of the multiple modeling servers, the transitions selected by virtual use of the context conversion terminal by the object frame under user control.
